(19) United States
(12) Patent Application Publication
(10) Pub. No.: US 2026/0363209 A1
(43) Pub. Date: Nov. 19, 2026

(54) HARNESS DEVICE FOR ANIMAL

(71) Applicant: HABLE HOUND INC, Dover, DE (US)

(72) Inventors: Xiaoxuan Chen, Shenzhen (CN); Jian Huang, Shenzhen (CN); Yanbo Zheng, Shenzhen (CN)

(21) Appl. No.: 19/727,008

(22) Filed: Jul. 1, 2026

(30) Foreign Application Priority Data
May 7, 2026 (CN) 202610616494.9

(51) Int. Cl. A01K 27/00

(52) U.S. Cl. CPC A01K 27/002

(57) ABSTRACT

A harness device for an animal includes a flexible harness base, at least two functional assemblies, a flexible connection portion, and a flexible connecting strap. The flexible harness base defines a first through hole and a second through hole. The functional assemblies have a loop-around structure. The flexible connecting portion allows the adjacent functional assemblies to undergo relative angular change in a worn state to adapt to curvature changes of the animal's body surface. The flexible connecting strap has a first end attached to an inner side of the flexible harness base, and a second end attached to the inner side of the flexible harness base. A portion of the flexible connecting strap between the first and second ends loops around the loop-around structure to mount each functional assembly onto the flexible harness base. The harness device provides good wearing comfort.

### CROSS REFERENCE TO RELATED APPLICATIONS

The present application claims the benefit of Chinese Patent Application No. 202610616494.9 filed on May 7, 2026, the contents of which are incorporated herein by reference in their entirety.

### FIELD OF THE INVENTION

The present application relates to the technical field of wearable electronic devices for animals, and more particularly to a harness device for an animal that ensures comfortable conformity when worn.

### BACKGROUND OF THE INVENTION

In conventional wearable electronic devices for animals, a single-piece housing is typically used, or multiple functional components are centrally mounted on a unified base or main housing, which is then connected to a wearing strap. As a result, during animal movements such as running, jumping, turning, and pitching, the curvature and deformation of the animal's torso surface are significant. A centralized or large-volume rigid structure tends to cause localized pressure on the animal and, due to bending and arching, leads to non-conformity between the centralized/large-volume rigid structure and the wearing strap on one hand and the animal's torso surface on the other hand, resulting in reduced wearing comfort and stress concentration.

Accordingly, there is a need for an improved harness device for an animal that overcomes one or more of the above-mentioned drawbacks.

### SUMMARY OF THE INVENTION

The present disclosure aims to provide a harness device for an animal that provides good wearing comfort.

To achieve the above objective, the harness device for an animal according to the present disclosure includes a flexible harness base, at least two functional assemblies spaced apart from each other, a flexible connection portion disposed between adjacent functional modules, and a flexible connecting strap positioned between the functional modules and the flexible harness base. The flexible harness base is fit around and configured to be worn on a torso surface of the animal, and defines a first through hole and a second through hole spaced apart from each other. The functional assemblies face an outer side of the flexible harness base, and each functional assembly is provided with a loop-around structure. The flexible connecting portion is disposed between adjacent functional assemblies, allowing the adjacent functional assemblies to undergo relative angular change in a worn state to adapt to curvature changes of the animal's body surface. The flexible connecting strap is disposed between the functional assemblies and the flexible harness base, the flexible connecting strap has a first end passing through the first through hole and attached to an inner side of the flexible harness base, and a second end passing through the second through hole and attached to the inner side of the flexible harness base. A portion of the flexible connecting strap between the first and second ends loops around the loop-around structure to mount each functional assembly onto the flexible harness base.

Compared with the prior art, in the present disclosure, the flexible connecting portion allows the adjacent functional assemblies to undergo angular change in the worn state, the functional assemblies can adapt to curvature changes of the animal's body surface under the action of the flexible connecting portion, thereby conforming to the body surface and avoiding stress concentration. In addition, the flexible connecting strap loops around the loop-around structure on each functional assembly to mount the functional assemblies onto the flexible harness base, thus the adjacent functional assemblies can slide along the flexible connecting strap while adaptively undergoing relative angular change in response to curvature changes of the animal's body surface, Thus, whether the adjacent functional assemblies approach each other (arching) or move away from each other (flattening), they do not cause the flexible harness base to arch or flatten, so that the flexible harness base remains in close conformity with the animal's torso surface, thereby providing better wearing comfort.

In a preferred embodiment, each functional assembly further defines a guide groove facing the flexible harness base for guiding the functional assembly to slide along the flexible connecting strap during angular change, the portion of the flexible connecting strap between the first and second ends being received in the guide groove.

In a preferred embodiment, the loop-around structure extends across the guide groove and is located at an end of the functional assembly remote from the flexible connecting portion.

In a preferred embodiment, at least one of the first end and the second end of the flexible connecting strap is detachably attached to the inner side of the flexible harness base via a hook-and-loop fastener or a snap fastener.

In a preferred embodiment, in the adjacent functional assemblies, each functional assembly protrudes toward the flexible harness base relative to the corresponding flexible connecting portion such that the adjacent functional assemblies and the flexible connecting portion together define a recess, the recess facing the portion of the flexible connecting strap between the first and second ends.

In a preferred embodiment, the adjacent functional assemblies and the flexible connecting portion have respective surfaces facing away from the flexible harness base that are flush with each other.

In a preferred embodiment, the flexible connecting portion is an elastomeric connecting member, a flexible sheet-like connecting member, a corrugated connecting member, a serpentine connecting member, or a fabric composite connecting member, and the flexible connecting portion allows the adjacent functional assemblies to rotate relative to each other.

In a preferred embodiment, an end of each functional assembly is provided with an end connection interface structure for cooperating with the flexible connecting portion, the end connection interface structure being connected to the flexible connecting portion by overmolding, snap-fitting, or interlocking.

In a preferred embodiment, each functional assembly defines a communication channel therein, and the flexible connecting portion defines an electrical connection channel aligned and in communication with the communication channel.

In a preferred embodiment, a conductive member is disposed within the electrical connection channel for electrically connecting the adjacent functional assemblies.

In a preferred embodiment, the conductive member is an electrical wire or a flexible printed circuit board.

In a preferred embodiment, the end connection interface structure includes an annular boss disposed around the communication channel and overmolded with the flexible connecting portion.

In a preferred embodiment, a sidewall of the annular boss defines an annular groove extending circumferentially around the annular boss and overmolded with the flexible connecting portion.

In a preferred embodiment, the flexible harness base has a back portion that faces upward in the worn state, a chest portion that faces downward in the worn state, and front side portions and rear side portions each connecting the chest portion and the back portion; the rear side portions, the front side portions, the back portion, and the chest portion together define side openings through which the animal's front legs extend out of the flexible harness base; the rear side portions, the back portion, and the chest portion together define a rear opening through which the animal's torso extends rearwardly out of the flexible harness base; the front side portions, the back portion, and the chest portion together define a front opening through which the animal's torso extends forwardly out of the flexible harness base.

In a preferred embodiment, the first through hole and the second through hole are located on the back portion; and the flexible connecting strap is disposed between the back portion and the functional assemblies.

### BRIEF DESCRIPTION OF THE DRAWINGS

The accompanying drawings facilitate an understanding of the various embodiments of this invention. In such drawings:

FIG. 1 is a perspective view of the harness device for an animal according to the present disclosure in a worn state;

FIG. 2 is a perspective view of the harness device for an animal of FIG. 1 from another angle;

FIG. 3 is a plan view of the harness device for an animal of FIG. 1 viewed from right to left;

FIG. 4 is a plan view of the harness device for an animal of FIG. 1 viewed from top to bottom;

FIG. 5 is a cross-sectional view taken along line A-A of FIG. 4;

FIG. 6 is an enlarged partial cross-sectional view of FIG. 5;

FIG. 7 is an enlarged view of portion B of FIG. 6;

FIG. 8 is an enlarged view of portion C of FIG. 6;

FIG. 9 is a perspective view of FIG. 2 with the harness base hidden; and

FIG. 10 is a view of FIG. 9 with the flexible connecting strap removed from the functional assemblies.

### DETAILED DESCRIPTION OF ILLUSTRATED EMBODIMENTS

To describe the technical content and structural features of the present disclosure in detail, further explanation is provided below with reference to the accompanying drawings and the embodiments.

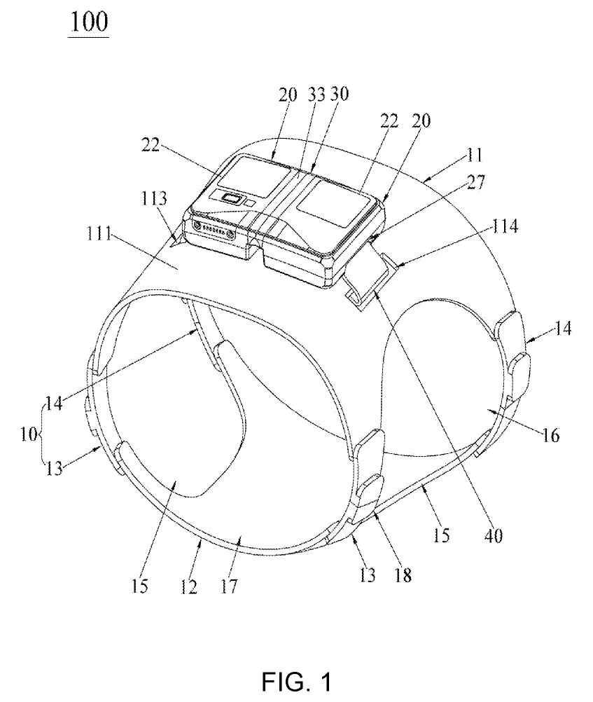

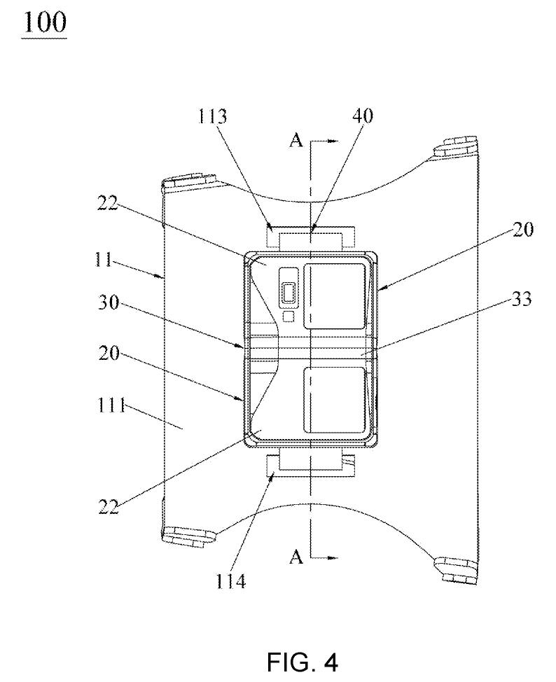

Referring to FIGS. 1, 2, 4, 5, and 6, a harness device 100 for an animal according to the present disclosure includes a flexible harness base 10 configured to fit around and be worn on a torso surface of an animal, two functional assemblies 20 spaced apart, a flexible connecting portion 30 disposed between adjacent functional assemblies 20, and a flexible connecting strap 40 disposed between the functional assemblies 20 and the flexible harness base 10.

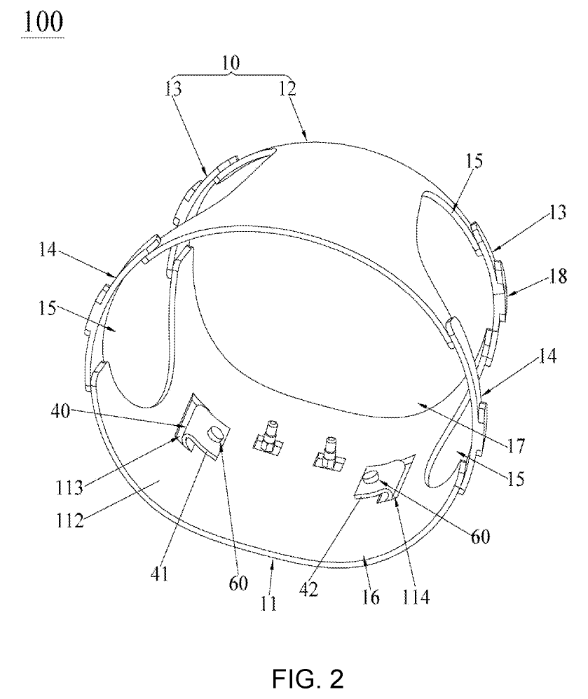

As shown in FIGS. 1 and 2, the flexible harness base 10 defines a first through hole 113 and a second through hole 114 spaced apart from each other. In the illustrated example, the first through hole 113 and the second through hole 114 are laterally spaced apart, although other configurations are possible. Specifically, referring to FIGS. 1-3, as an exemplary configuration, the flexible harness base 10 has a back portion 11 that faces upward in the worn state (i.e., when the flexible harness base 10 is worn on the animal's torso surface), a chest portion 12 that faces downward in the worn state, and front side portions 13 and rear side portions 14 each connecting the chest portion 12 and the back portion 11. The rear side portions 14, the front side portions 13, the back portion 11, and the chest portion 12 together define side openings 15 through which the animal's front legs extend out of the flexible harness base 10. As shown in FIG. 1, the front side portions 13 and the rear side portions 14 are arranged in a left-right opposing configuration, thus providing two side openings 15—one left side opening and one right side opening—so that the animal's left and right front legs can extend through the respective side openings 15. The rear side portions 14, the back portion 11, and the chest portion 12 together define a rear opening 16 through which the animal's torso extends rearwardly out of the flexible harness base 10. The front side portions 13, the back portion 11, and the chest portion 12 together define a front opening 17 through which the animal's torso extends forwardly out of the flexible harness base 10. Thus, in the worn state of the flexible harness base 10, the animal's front legs extending through the side openings 15 prevent the flexible harness base 10 from undesirably rotating about the animal's torso surface in the circumferential direction, so that the back portion 11 remains stably facing upward and the chest portion 12 remains stably facing downward. It should be understood that the flexible harness base 10 may also have other configurations known in the art, and is not limited to the configuration shown in FIGS. 1-3.

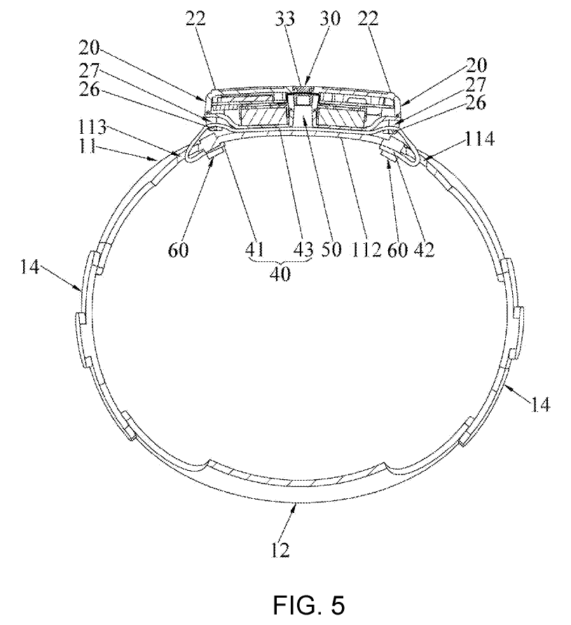

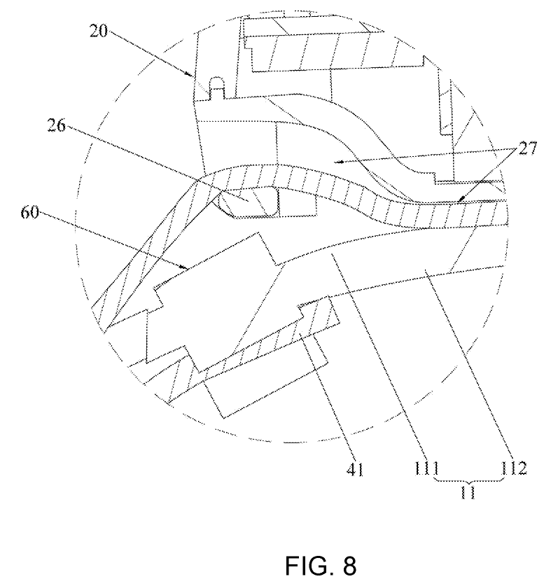

The functional assemblies 20 face an outer side 111 of the flexible harness base 10. As shown in FIGS. 5-10, each functional assembly 20 is provided with a loop-around structure 26. In FIG. 8, the loop-around structure 26 has a cross-section with rounded corners, although other shapes are possible.

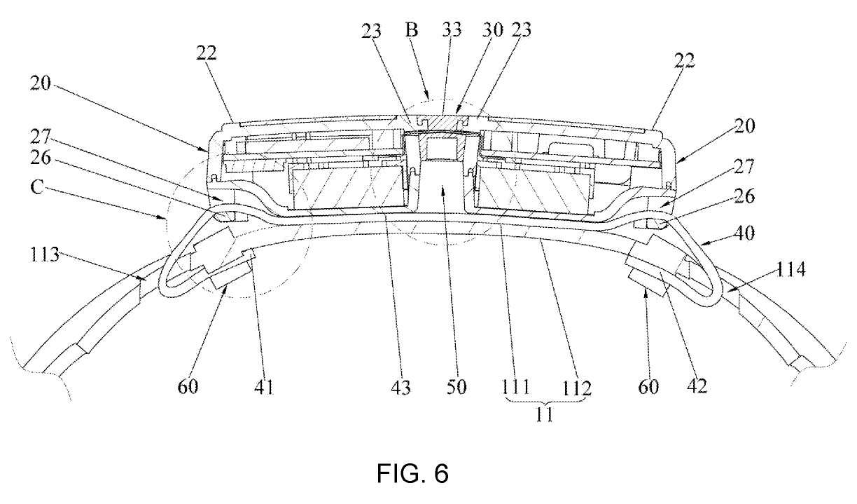

Furthermore, the flexible connecting portion 30 allows adjacent functional assemblies 20 to undergo relative angular change in the worn state. For example, in FIG. 6, the flexible connecting portion 30 allows adjacent functional assemblies 20 to move toward each other (decreasing the angle between them) or away from each other (increasing the angle between them) to adapt to curvature changes of the animal's body surface. As an exemplary configuration, the flexible connecting portion 30 may be an elastomeric connecting member, a flexible sheet-like connecting member, a corrugated connecting member, a serpentine connecting member, or a fabric composite connecting member. By virtue of bending and automatic resetting of the flexible connecting portion 30, adjacent functional assemblies 20 are allowed to rotate relative to each other, thereby achieving angular change.

A first end 41 of the flexible connecting strap 40 passes through the first through hole 113 and is attached to an inner side 112 of the flexible harness base 10. A second end 42 of the flexible connecting strap 40 passes through the second through hole 114 and is attached to the inner side 112 of the flexible harness base 10. A portion 43 of the flexible connecting strap 40 between the first end 41 and the second end 42 loops around the loop-around structure 26, thereby mounting each functional assembly 20 onto the flexible harness base 10 (see FIG. 6). This configuration allows adjacent functional assemblies 20 to slide along the flexible connecting strap 40 when they move toward or away from each other. Further details are provided below.

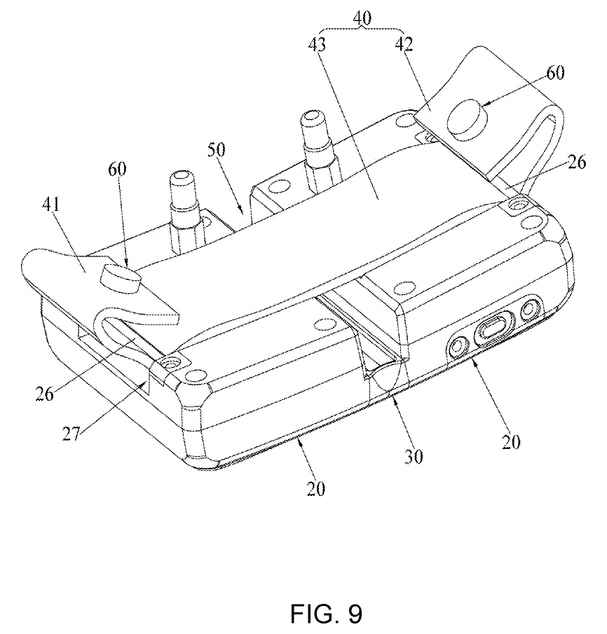

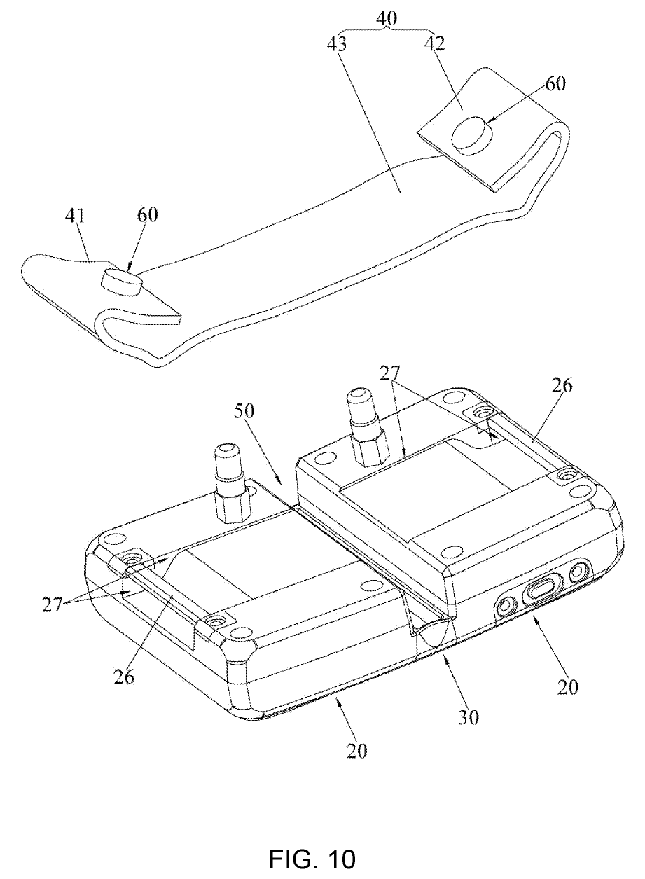

As shown in FIGS. 8-10, in an exemplary configuration, each functional assembly 20 further defines a guide groove 27 facing the flexible harness base 10 for guiding the functional assembly 20 to slide along the flexible connecting strap 40 during angular change. The portion 43 of the flexible connecting strap 40 between the first end 41 and the second end 42 is received in the guide groove 27 (see FIGS. 8 or 9). The loop-around structure 26 extends across the guide groove 27 and is located at an end of the functional assembly 20 remote from the flexible connecting portion 30. For example, in FIG. 10, the left loop-around structure 26 is located at the left end of the left functional assembly 20, and the right loop-around structure 26 is located at the right end of the right functional assembly 20. By virtue of the configuration in which the loop-around structure 26 extends across the guide groove 27 and is located at the end of the functional assembly 20 remote from the flexible connecting portion 30, and the portion 43 of the flexible connecting strap 40 between the first end 41 and the second end 42 is received in the guide groove 27, the flexible connecting strap 40 more reliably connects the functional assemblies 20 to the flexible harness base 10 and effectively restricts the functional assemblies 20 to sliding only along the flexible connecting strap 40 during angular change.

As shown in FIGS. 2, 5, 6, 9, and 10, in an exemplary configuration, the first end 41 and the second end 42 of the flexible connecting strap 40 are each detachably attached to the inner side 112 of the flexible harness base 10 via snap fasteners 60, thereby facilitating assembly and disassembly of the functional assemblies 20 to and from the flexible harness base 10. Alternatively, the first end 41 and the second end 42 may be detachably attached to the inner side 112 of the flexible harness base 10 via hook-and-loop fasteners, or at least one of the first end 41 and the second end 42 may be attached via a hook-and-loop fastener or a snap fastener 60. Thus, the illustrated configuration shown in FIGS. 2, 5, 6, 9 and 10 is not limiting.

Additionally, as shown in FIGS. 5, 6, 7, 9. and 10, in an exemplary configuration, in adjacent functional assemblies 20, each functional assembly 20 protrudes toward the back portion 11 relative to the corresponding flexible connecting portion 30 (i.e., the flexible connecting portion 30 between two adjacent functional assemblies 20). As a result, the adjacent functional assemblies 20 and the corresponding flexible connecting portion 30 together define a recess 50. The recess 50 faces the portion 43 of the flexible connecting strap 40 between the first end 41 and the second end 42, allowing the flexible connecting portion 30 to more smoothly permit relative angular change between the adjacent functional assemblies 20.

As shown in FIGS. 5, 6, and 7, in an exemplary configuration, the surfaces 22, 33 of the adjacent functional assemblies 20 and the corresponding flexible connecting portion 30 that face away from the flexible harness base 10 are flush with each other, making the harness device 100 neater and more aesthetically pleasing.

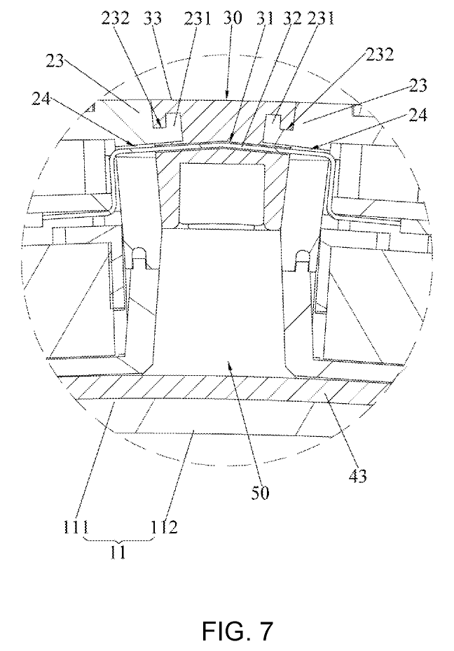

As shown in FIG. 7, in an exemplary configuration, an end of each functional assembly 20 is provided with an end connection interface structure 23 for cooperating with the flexible connecting portion 30. In FIG. 7, the end connection interface structure 23 is overmolded with the flexible connecting portion 30, thereby ensuring reliable connection and sealing between the functional assembly 20 and the flexible connecting portion 30, and improving waterproof, dustproof, and impact resistance capabilities. Alternatively, the end connection interface structure 23 may be snap-fitted or interlocked with the flexible connecting portion 30.

Furthermore, as shown in FIG. 7, in an exemplary configuration, each functional assembly 20 defines a communication channel 24 therein, and the flexible connecting portion 30 defines an electrical connection channel 31 therein aligned and communicating with the communication channel 24. A conductive member 32 is disposed within the electrical connection channel 31 for electrically connecting adjacent functional assemblies 20. The conductive member 32 may be an electrical wire or a flexible printed circuit board, thereby meeting the requirements for power and signal transmission between adjacent functional assemblies 20 and improving the reliability and consistency of wiring and electrical connection between the functional assemblies 20.

As shown in FIG. 7, in an exemplary configuration, the end connection interface structure 23 includes an annular boss 231 disposed around the communication channel 24 and overmolded with the flexible connecting portion 30, so as to increase the overmolding area between the functional assembly 20 and the flexible connecting portion 30. Optionally, a sidewall of the annular boss 231 defines an annular groove 232 extending circumferentially around the annular boss 231 and overmolded with the flexible connecting portion 30, thereby further increasing the overmolding area. Although FIG. 7 shows the annular boss 231 and the annular groove 232 as having circumferentially open ends, it is also possible that the annular boss 231 and the annular groove 232 have circumferentially closed (continuous) configurations, so the illustrated configuration shown in FIG. 7 is not limiting.

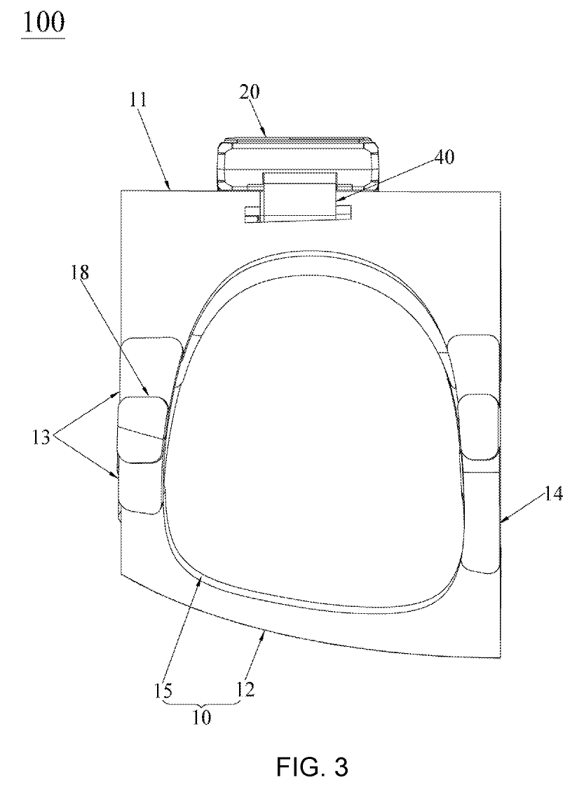

As shown in FIGS. 1-3, in an exemplary configuration, the flexible harness base 10 further includes an opening/closing structure 18 for separating or joining the front side portions 13. The opening/closing structure 18 may be, but is not limited to, a snap fastener or a hook-and-loop fastener, improving the convenience of wearing the harness device 100. Although FIGS. 1 and 3 show the opening/closing structure 18 separating or joining the left front side portion 13, the opening/closing structure 18 may also separate or join the right front side portion 13, or may separate or join the left and/or right rear side portions 14. Thus, the illustrated configuration is not limiting.

Compared with the prior art, in the present disclosure, the flexible connecting portion 30 allows the adjacent functional assemblies 20 to undergo angular change in the worn state, the functional assemblies 20 can adapt to curvature changes of the animal's body surface under the action of the flexible connecting portion 30, thereby conforming to the body surface and avoiding stress concentration. In addition, the flexible connecting strap 40 loops around the loop-around structure 26 on each functional assembly 20 to mount the functional assemblies 20 onto the flexible harness base 10, thus the adjacent functional assemblies 20 can slide along the flexible connecting strap 40 while adaptively undergoing relative angular change in response to curvature changes of the animal's body surface, Thus, whether the adjacent functional assemblies 20 approach each other (arching) or move away from each other (flattening), they do not cause the flexible harness base 10 to arch or flatten, so that the flexible harness base 10 remains in close conformity with the animal's torso surface, thereby providing better wearing comfort.

It is noted that the flexible harness base 10 may be made of fabric. Although the drawings show two functional assemblies 20, the number of functional assemblies 20 may be three, four, or more, so the illustrated number is not limiting. When the flexible harness base 10 has the back portion 11, the chest portion 12, the front side portions 13, and the rear side portions 14, the first through hole 113 and the second through hole 114 are located on the back portion 11, the functional assemblies 20 face the outer side 111 of the back portion 11, the flexible connecting strap 40 is disposed between the back portion 11 and the functional assemblies 20, the first end 41 of the flexible connecting strap 40 is attached to the inner side 112 of the back portion 11, and the second end 42 of the flexible connecting strap 40 is attached to the inner side 112 of the back portion 11 (see FIG. 6).

The above disclosure is only preferred embodiments of the present disclosure and shall not be used to limit the scope of rights of the present disclosure. Accordingly, equivalent variations made in accordance with the claims of the present disclosure shall fall within the scope of the present disclosure.

What is claimed is:

1. A harness device for an animal, comprising:
a flexible harness base configured to fit around and be worn on a torso surface of the animal, and defining a first through hole and a second through hole spaced apart from each other;
at least two functional assemblies facing an outer side of the flexible harness base, each functional assembly being provided with a loop-around structure;
a flexible connecting portion disposed between adjacent functional assemblies, the flexible connecting portion allowing the adjacent functional assemblies to undergo relative angular change in a worn state to adapt to curvature changes of the animal's body surface; and
a flexible connecting strap disposed between the functional assemblies and the flexible harness base, the flexible connecting strap having a first end passing through the first through hole and attached to an inner side of the flexible harness base, and a second end passing through the second through hole and attached to the inner side of the flexible harness base, wherein a portion of the flexible connecting strap between the first and second ends loops around the loop-around structure to mount each functional assembly onto the flexible harness base.

2. The harness device according to claim 1, wherein each functional assembly further defines a guide groove facing the flexible harness base for guiding the functional assembly to slide along the flexible connecting strap during angular change, the portion of the flexible connecting strap between the first and second ends being received in the guide groove.

3. The harness device according to claim 2, wherein the loop-around structure extends across the guide groove and is located at an end of the functional assembly remote from the flexible connecting portion.

4. The harness device according to claim 1, wherein at least one of the first end and the second end of the flexible connecting strap is detachably attached to the inner side of the flexible harness base via a hook-and-loop fastener or a snap fastener.

5. The harness device according to claim 1, wherein, in the adjacent functional assemblies, each functional assembly protrudes toward the flexible harness base relative to the corresponding flexible connecting portion such that the adjacent functional assemblies and the flexible connecting portion together define a recess, the recess facing the portion of the flexible connecting strap between the first and second ends.

6. The harness device according to claim 5, wherein the adjacent functional assemblies and the flexible connecting portion have respective surfaces facing away from the flexible harness base that are flush with each other.

7. The harness device according to claim 1, wherein the flexible connecting portion is an elastomeric connecting member, a flexible sheet-like connecting member, a corrugated connecting member, a serpentine connecting member, or a fabric composite connecting member, and the flexible connecting portion allows the adjacent functional assemblies to rotate relative to each other.

8. The harness device according to claim 1, wherein an end of each functional assembly is provided with an end connection interface structure for cooperating with the flexible connecting portion, the end connection interface structure being connected to the flexible connecting portion by overmolding, snap-fitting, or interlocking.

9. The harness device according to claim 8, wherein each functional assembly defines a communication channel therein, and the flexible connecting portion defines an electrical connection channel aligned and in communication with the communication channel.

10. The harness device according to claim 9, wherein a conductive member is disposed within the electrical connection channel for electrically connecting the adjacent functional assemblies.

11. The harness device according to claim 10, wherein the conductive member is an electrical wire or a flexible printed circuit board.

12. The harness device according to claim 8, wherein the end connection interface structure includes an annular boss disposed around the communication channel and overmolded with the flexible connecting portion.

13. The harness device according to claim 12, wherein a sidewall of the annular boss defines an annular groove extending circumferentially around the annular boss and overmolded with the flexible connecting portion.

14. The harness device according to claim 1, wherein the flexible harness base has a back portion that faces upward in the worn state, a chest portion that faces downward in the worn state, and front side portions and rear side portions each connecting the chest portion and the back portion; the rear side portions, the front side portions, the back portion, and the chest portion together define side openings through which the animal's front legs extend out of the flexible harness base; the rear side portions, the back portion, and the chest portion together define a rear opening through which the animal's torso extends rearwardly out of the flexible harness base; the front side portions, the back portion, and the chest portion together define a front opening through which the animal's torso extends forwardly out of the flexible harness base.

15. The harness device according to claim 14, wherein the first through hole and the second through hole are located on the back portion; and the flexible connecting strap is disposed between the back portion and the functional assemblies.
